(19) United States
(12) Patent Application Publication
(10) Pub. No.: US 2006/0076397 A1
(43) Pub. Date: Apr. 13, 2006

(54) Method and system for drive through retail operation

(76) Inventor: Geoffrey Langos, Chesapeake, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/963,961

(22) Filed: Oct. 13, 2004

(51) Int. Cl. G06F 17/00

(52) U.S. Cl. 235/375

(57) ABSTRACT

A microprocessor retail operation accepts orders from customers that are remote from the operation. A caller identification device or voice recognition device identifies the customer and accesses an individualized database including data representative of the customer. The order for goods is filled such that it awaits arrival of the customer. The customer is identified upon arrival at the location of the retail operation. The system alerts an employee of the customer's arrival at the retail store. The transaction is consummated when a microprocessor records the transaction and an employee delivers the ordered goods.

### FIELD OF THE INVENTION

The present invention generally relates to an apparatus and method for conducting a drive-through retail operation. More particularly, the invention relates to a computer aided retail operation that assists the retail operator and minimizes a customer wait time. Thus, the present invention maximizes the efficiency of a drive-through operation while increasing both retail owner profitability and customer loyalty. The system also provides individualized attention.

The invention comprises a process for remotely ordering products, traveling to a retail operation that has filled the order, and picking up the order. A customer contacts a retail operation to place an order. An identification means identifies the customer when the order is placed. The identification means may comprise a caller identification means that identifies a telephone number of the caller, voice recognition software or other such means discuss hereinafter. The customer proceeds to the retail operation having a building that includes at least two ingress lanes for allowing automobiles to enter the building. The ingress lanes include crossover lanes for efficiently controlling the flow of customers. Cameras, coupled to the microprocessor, generate a picture of a license plate on the automobile. The picture is analyzed to determine at least numerals or letters on the license plate. The sequence of numerals or letters on the license plate is compared with others stored in a database and used to identify the appropriate customer who has placed the order. The customer proceeds to a point of sale terminal that displays the customer's order and alerts a store employee to the location of the customer's order. The microprocessor stores data relating to the location of the customer's order as well as other transactional information such as credit card numbers and customer unique information for aiding the store employee in completing the transaction. The customer takes control of his ordered products and proceeds through the building to exit the operation.

### BACKGROUND OF THE INVENTION

Many fast food restaurants include a “drive-through” where a customer can drive up to the restaurant, order and receive food without leaving his car. Typically, this type of drive-through includes a sign displaying the foods sold by the restaurant. The customer, through use of a speaker and microphone, places an order with an attendant and pulls around to a pickup window where he pays for the ordered food. Meanwhile, the attendant fills the order and transfers the ordered food to the customer upon receipt of payment.

This type of drive-through is convenient to use and a time saver for customers. Thus, it helps promote customer satisfaction and repeat purchases. Moreover, a restaurant having a drive-through can serve food to many more customers than one not having a drive-through.

### SUMMARY OF THE INVENTION

The present invention is a novel type drive-through retail store that includes software and hardware that allows a customer to place an order from a location remote from the store. A microprocessor controls various operations of the retail store. Some of these operations might include identifying customers when an order is placed, accessing customer unique information, communicating with a customer that may include accepting orders, calculating a cost of an order, providing directions to the retail operation, prioritizing the filling of multiple orders to include controlling use of storage bins, identifying customers upon arrival at the retail store matching the identified customer to the placed order and alerting an employee of the store when the customer arrives while informing the employee where the order is stored.

The system includes a caller identification means, voice recognition software or similar means that identifies the customer when he places an order. The microprocessor receives identification information and compares it to stored customer information to identify the customer placing the order. If the caller has not placed an order previously, the microprocessor cues the caller to provide pertinent information such as name, address, license plate number, payment information and telephone number. This information is then stored in a database individualized for the customer. If voice recognition software is being used, the microprocessor may also collect and store speech pattern information for identifying the caller in the future.

In another embodiment of the invention, a global positioning system or location identification means determines the location of the caller and may calculate an arrival time based upon factors such as the distance between the caller and the retail operation, routes that may be taken to get to the retail operation, quantity, size and storage location of ordered items, as well as weather and traffic conditions. Information relating to the location of the customer is relayed to the microprocessor. While accounting for the various conditions previously mentioned, the microprocessor uses this information to prioritize the filling of orders by store employees. Upon arrival at the store, the customer is positively identified by one of several means including but not limited to cameras, GPS data, vehicle identification number, or vehicle transmitter tag, and alerts a store employee of the customer's arrival and bin or area location where the customers order is stored after being filled. The store employee delivers the ordered goods to the customer who then accepts them. Upon consummation of the transaction, the customer pays for the ordered items with cash or the amount owed by the customer is debited from a credit card account or other similar account, which may be kept on file in a database for speedy POS transactions.

In a further embodiment, multiple retail stores link together via a web-based network. An inventory of the various items for each store is maintained in a database that may be accessed by multiple stores. A customer calls up one of the stores and places an order. The microprocessor may suggest an alternative store that is closer for filling the order. Or, if the item is in stock in one store and not another, the microprocessor alerts the customer of the location of the store having the ordered item. Upon confirmation, the microprocessor directs the customer to the nearest retail operation for pickup of the ordered products.

It is an object of the invention to provide a drive-through type retail operation that reduces customer-shopping time by optimizing product ordering. A customer can shop or place an order for an item while in their car waiting in traffic or traveling to the retail operation. Alternatively, the customer may place an order using a personal digital assistant, computer or other such electronic device that provides voice or e-mail communications.

It is another object of the invention to more efficiently provide retail goods to disabled customers. Attendants or store employees can deliver ordered goods to disabled customers via curbside service.

It is another object of the invention to increase profitability of retail storeowners by eliminating shoplifting. Since customers never actually enter the portion of the store where the retail goods are stored, shoplifting will be eliminated.

It is another object of the invention to provide expeditious, unparalleled retail service to customers.

It is a further object of the invention to provide incentives to repeat customers. This system allows a retailer to offer promotions to customers because data relating to purchasing habits of the customer is readily available. Thus, the retailer can quickly identify customers that may be interested in a new type of product by analyzing the purchasing habits of the customer.

It is a further object of the invention to improve profitability of a retail operation by reducing the amount of time necessary for training personnel. This invention reduces overhead costs, optimizes shelf life of products, automatically reorders products, and tracks sales of products efficiently.

Additional objects and advantages of the invention will be set forth in part in the description that follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1A is a schematic view of the drive-through retail operation of the present invention. FIG. 1B is a block diagram of the hardware of an embodiment of the invention.

FIG. 2 is a schematic view of an embodiment of the invention having multiple operations linked together via a communications network.

FIG. 3 is a schematic view of a single store embodiment of the present system.

FIG. 4 is a schematic view of a single store embodiment and showing databases used in operation of the store.

FIG. 5 is a schematic view of a second single store embodiment and showing databases.

FIG. 6 is a flow chart showing an operation sequence of a first operational embodiment of the invention.

FIG. 7 is a flow chart showing an operation sequence of a second operational embodiment of the invention.

FIG. 8 is a perspective view of a cueing device for directing customers through the drive through and crossover lanes in the retail operation.

### DETAILED DESCRIPTION OF THE INVENTION

The following is the preferred embodiment or best mode for carrying out the invention. It should be noted that this invention is not limited by the discussion of the preferred embodiment and that skilled artisans can readily understand that the invention may be modified without deviating from the spirit of the invention.

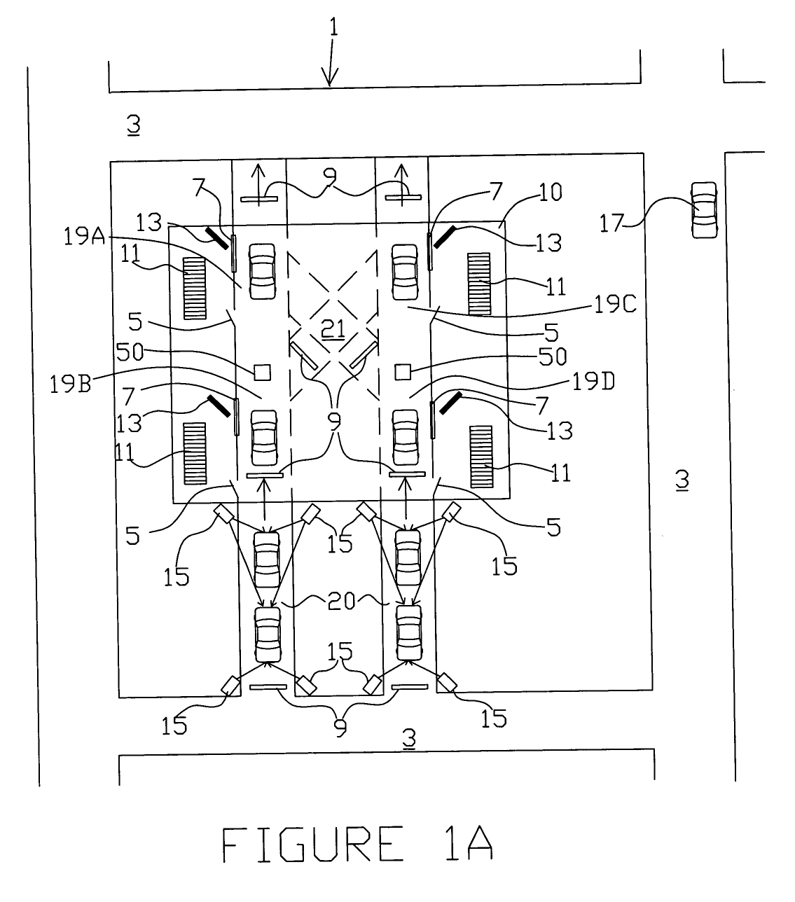

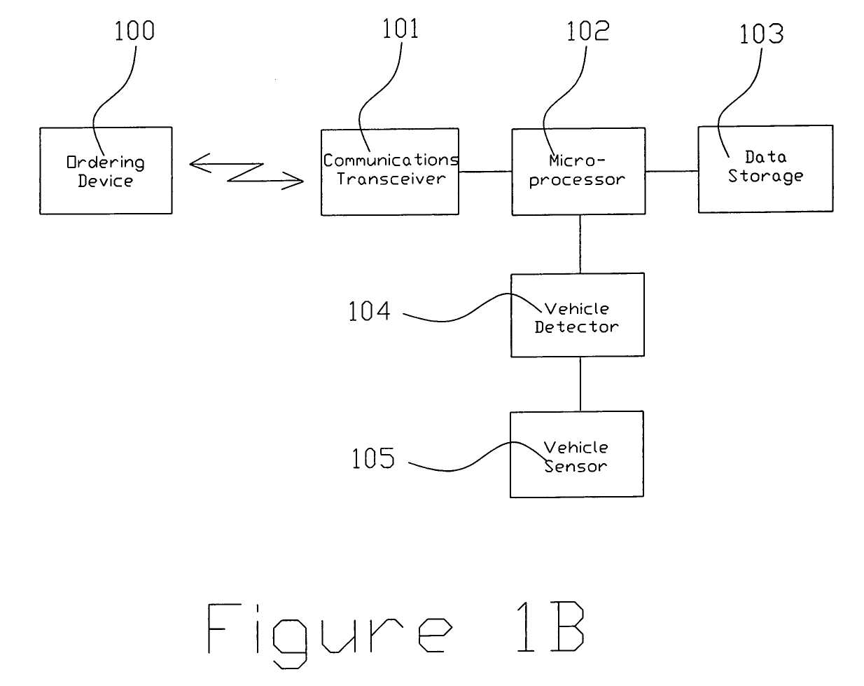

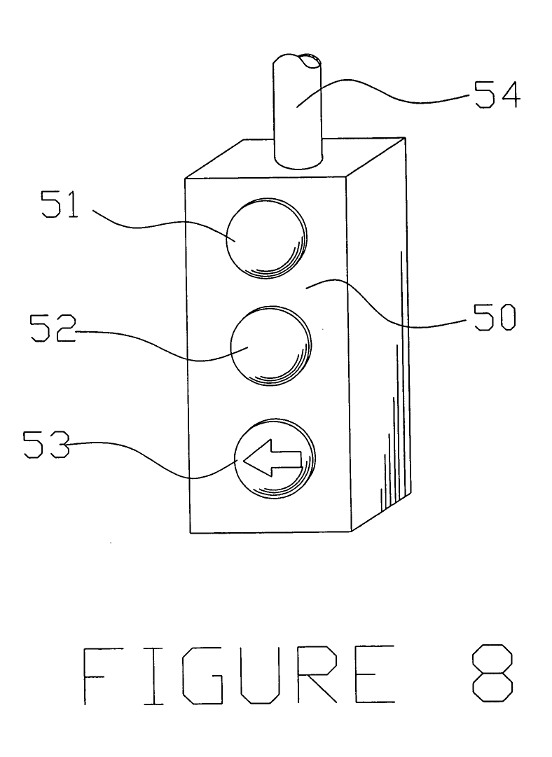

Referring now to FIG. 1A, the retail store operation 1 includes a building or shelter 2 equipped with at least two drive-up windows 7 and a loading area 19. Preferably, the loading area 19 is covered to protect those loading the vehicle from the elements. In the preferred embodiment, the operation 1 includes two entryways 20. Each entryway 20 includes two or more loading areas that include a door 5, a storage area 11, a display terminal 13 and a window 7. Traffic control devices 50, as shown in FIG. 8, control the flow of automobiles 17 through the retail operation 1. In the preferred embodiment, the building is located between two streets such that automobiles can quickly enter and exit the operation. However, it is easily recognized that the operation can be implemented using a wide variety of ingress and egress avenues and approaches. Multiple drive-through lanes and loading areas may be included in the operation.

Cameras 15 may be mounted along the entryways 20 for reproducing a digital image of license plates on each automobile 17 that enters the operation 1. Operation of each camera 15 is controlled by a vehicle sensor 9 such as a pressure sensor or optical detector unit comprising a light source and an a light detector. When an automobile actuates the camera 15, an image of the license plate is reproduced to identify the customer. If the automobiles 17 are equipped with a smart tag as previously mentioned, then the vehicle sensor may be substituted for a smart tag detector. The use of a smart tag detection unit located near or within the building 5 identifies an automobile 17 as it enters the operation and alleviates the necessity for the pressure sensor or optical detector unit as well as the camera.

Window 7 allows a store employee to pass smaller orders through it to the customer, as well as transfer of information between the customer and employee. Door 5 provides access to the loading area for larger orders. Thus, a customer may enter the storage area to pickup a filled order and transfer it to his automobile; alternatively, the store employee may deliver the ordered items to the customer through door 5. A storage area 11 may be provided with storage bins into which filled orders may be placed. In the preferred embodiment, a storage area 11 is provided for each terminal 13. However, one storage area 11 may be provided for each entryway 20.

The crossover lanes 21 allow optimization of traffic flowing through the retail operation 1. Traffic directing devices 50, as more clearly shown in FIG. 8, may be hung from the roof via a support 54. Each device 50 is equipped with a red light 51, a green light 52 and a direction light 53. The red light 51 informs a customer that the loading area 19 ahead is occupied and the customer should maintain his present position. A green light 52 indicates that the customer may proceed to the loading area 19 ahead for receiving his ordered goods. A direction light 53 may direct the customer to enter a crossover lane 21 to either proceed to another loading area 19 or leave the operation. In one example, a later arriving customer having a small order may proceed to loading area 19B. If loading area 19A is occupied by another having an unfilled order, the later arriving customer may accept his goods and proceed through a crossover lane 21 to exit the operation through loading area 19C. As can be easily recognized, the use of the crossover lanes 21 may greatly enhance the operation of the facility.

FIG. 1B is a block diagram of the present system. A customer utilizes a remote ordering device 100 to place an order with a microprocessor 102 that controls and monitors the retail operation. The remote ordering device 100 may include a personal digital assistant, a land-line telephone, a cellular telephone, a text messaging device, a computer, or any other communication device that transmits any form of electronic communications. A receiving device 101 is connected to the microprocessor 102 for receiving electronic communications from the ordering device 100. The receiving device may include a modem, a wireless link, a direct subscriber line or other broadband connection means, or any device for electronically communicating between a remote communication device 100 and a microprocessor 102. The microprocessor 102 is coupled to both a data storage device 103 and a vehicle identification means 104. The data storage device 103 is an electronic media that stores information relating to products maintained in an inventory as well as customer unique information. The vehicle identification means 104 provides information relating to a detected vehicle to the microprocessor 102. A sensor 105 is coupled to the vehicle identification means 104 for triggering it when a vehicle 17 enters the operation.

After an order has been placed by a customer, the customer proceeds to the location of the retail store operation 1. Pressure sensors 9, such as those used at many stop lights, are embedded in the drive-through lanes 20 and detect the arrival of a customer automobile 17. Alternatively, a light transmitter and receiver (optical detector unit) may detect the presence of a vehicle as discussed previously. It will be readily apparent to those skilled in the art that other alternative vehicle detection systems may be employed to detect the presence of a customer vehicle.

The vehicle detection system triggers cameras 15 located on the ingress side of the building to reproduce an image of a customer's license plate on each automobile 17 entering the operation. This image is digitized and recognized using known recognition techniques that recognize the various characters on the license plate. A microprocessor 102, which controls the operation of the store, compares the digitized image of characters with license numbers stored in a database that correspond to customers. Thus, the system automatically recognizes the customer upon entry into the drive-through lane. Focusing of the camera may be automatic using known focusing techniques and software. Alternatively, the focusing of the camera may be achieved manually via a store employee. The customer then proceeds to a drive-up window or loading area where he picks up his ordered products and continues on his way. If however, the customer is using a different car, the system may cue the customer for his correct license plate at the time that the customer places the order. Alternatively, the customer may provide his name, or other identifying information, to a store employee at the drive-up window or loading area.

The building may include a warehouse storage area having storage shelves or areas. In the preferred embodiment, retail items are stored in particular areas or storage bins that include reference characters. When an order occurs, the microprocessor reviews databases having information relating to both the commodity ordered and its location. A store employee who is in charge of filling the order may be prompted by a display screen or alternatively by a printout with a list of ordered items and their location. The employee then proceeds to the corresponding bin or storage area and retrieves the appropriate number of items for packaging them. Once the order is filled, the employee transports the packaged items to a packaged product storage area 11, which may also include storage shelves or bins with reference characters. Using an input device such as a keyboard or barcode scanner, the employee then enters the bin, shelf or location where the packaged items have been deposited. When the customer arrives at the store, an employee reviews the location of the packaged items on a display screen, retrieves the item and delivers it to the customer.

The microprocessor 101 may include an inventory type program that tracks the goods ordered and deducts an item when one is removed from inventory to fill an order. The microprocessor 101 may then reorder or prompt an employee to reorder the items when the quantity of an item or produce falls below a preset threshold.

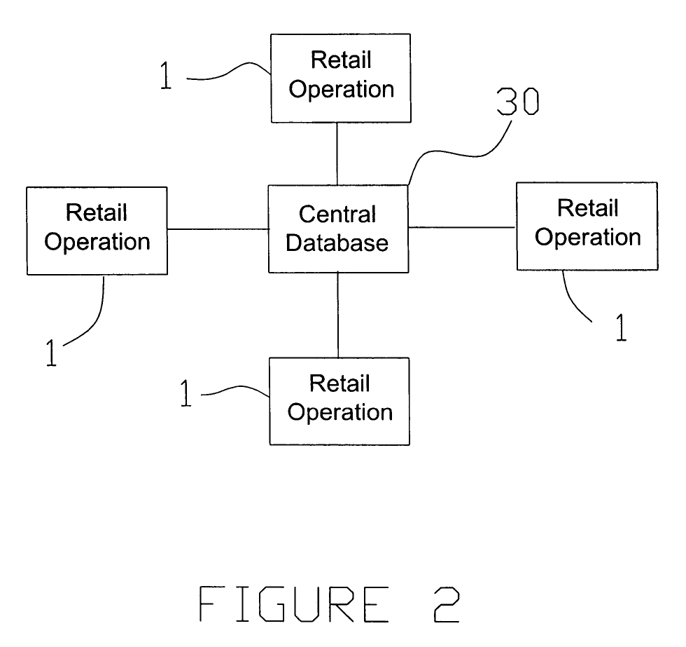

Referring now to FIG. 2, which shows an embodiment of the invention where multiple retail store locations are linked together. In this embodiment, each retail operation 1 is linked together via a communication platform such as the Internet. The communication platform may include known technologies such as broadband or dial-up communication systems coupled with Internet service providers such as America Online or Microsoft Network.

A central database 30 stores information on all customers, as well as inventory maintained at each retail operation 1. The information relating to the inventory is regularly updated at near real time. In this embodiment, the central database 30 is depicted as being separate from the retail operations. However, it is easily recognizable that the database may be located at one or more of the retail operations. Each store 1 includes a microprocessor 101 for controlling the operations. The microprocessor may include a personal computer that is equipped to access the Internet. Each microprocessor communicates with the others via an Internet service provider or dedicated connections.

The retail operations 1 may also include websites that can be accessed by customers for ordering items online. As is known in the art, these websites may be hosted either by a processor located at a retail operation or remote from the retail operation. The retail operations may share a single website that directs customers to the nearest retail operation once an order has been placed.

In this embodiment, a microprocessor may collect data relating to a customer's location at the time of order. This data may be automatically transmitted to the microprocessor via a global positioning system receiver coupled with a transmitter. The data is used to suggest the closest retail operation to the customer. The customer may be provided directions using popular mapping programs such as Map Quest™ or the like. The microprocessor may use a voice synthesizer to relay directions to the customer. Alternatively, a store employee may provide the directions to the customer, or directions could be sent to the customer's mobile device such as a cell phone or Portable Digital Assistant. The microprocessor may prioritize customer orders as previously mentioned.

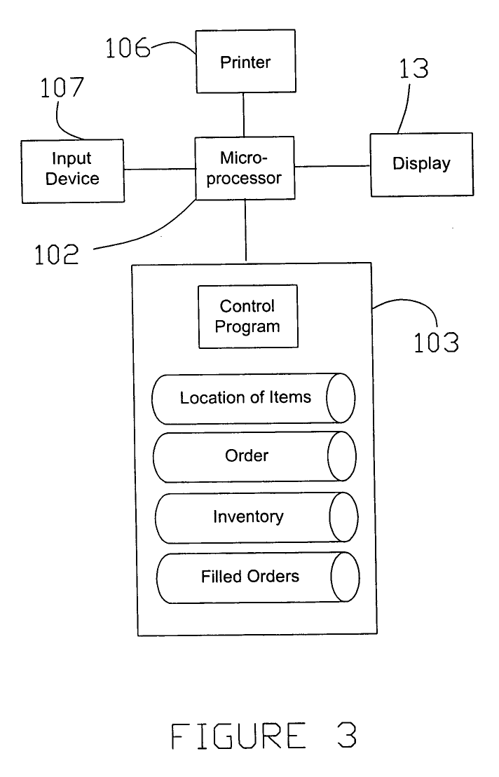

Referring to FIG. 3, which is a detailed view of the operating system that controls a single retail operation of the invention. The system includes a microprocessor 102 for controlling operational features, as well as accessing and manipulating data. A data storage device 103 stores data as discussed below. The system further comprises input devices 107 which may include any known input devices such as keyboards and bar code scanners as mentioned hereinafter. The system also includes output devices such as displays 13 and printers 106. It should be noted that the microprocessor 102 might control more than one store operation. For example, a remote store may be controlled as well as the store in which the microprocessor is located. It should also be noted that the term “microprocessor” should be interpreted broadly to include a single processor or a plurality of processors working together to control various operational aspects of the instant invention. The microprocessor may communicate with the other parts of the system through known various techniques and hardware that may include cables, wires, radio frequencies, light waves, combinations thereof, or other known methods and means.

An input device 107, such as a keyboard, mouse, bar code scanner, voice input means or synthesizer, caller identification hardware, Radio Frequency ID tags (RFID's), combination thereof, or other known electrical devices that provide input to the microprocessor, communicates with the microprocessor. The input device may also include sampled images from the camera discussed above or input from the vehicle sensors or GPS devices previously mentioned. Information from the input device is used by the microprocessor to achieve various tasks. For example, a keyboard or mouse may be used to cue the microprocessor to display an amount of inventory for a particular item, its physical location, or when a re-order is necessary. The bar code scanner may be used to track various items throughout the stocking, packaging and delivery phases. The voice input means or synthesizer may be used to verbally order items or control the microprocessor as well as convert output from the microprocessor into a voice recognizable language. The microprocessor also communicates with a display and a printer for providing an output to a user. The display may be of any type of known video monitors and may include a liquid crystal display or a light emitting diode display.

A data storage device 103 coupled to the microprocessor 102 includes various databases. A control program contains instructions for controlling the operation of the microprocessor. The control program also includes instruction for manipulating the various databases discussed below.

The data storage device further includes an inventory database that tracks the amount of items left in inventory. The operating instructions in the control program may include a subroutine or other program structure that tracks the amount of each item and automatically reorders the item when the total number of items in inventory falls below a preset threshold. Alternatively, the operation instructions may be written to alert a store employee when an item needs to be reordered.

The data storage device also includes a location of items database. The location of items database lists all the items in inventory and each item's location in the warehouse or storage area. This database may also list acceptable substitute products and is typically accessed by an employee when filling an order or restocking the warehouse. For example, tissues may be located on aisle one, shelf two in bin #2 in the warehouse. It should be noted this database may be included as part of the inventory database.

An order database includes data on ordered items. When an order is placed by a customer, the order is stored in the order database. The operational instructions contained in the control program may use other data such as the location of each customer and number of ordered items to prioritize the filling of the orders. For example, a customer who places an order for two items and is located within one mile of the retail operation may have his order filled before a customer who has ordered ten items and is twenty miles from the retail operation. Traffic conditions provided to the microprocessor through an electronic means may also be factored into the prioritizing of the order. Time will also be considered in this prioritization of orders such that orders that have been waiting to be filled for longer time periods may be pushed to the top of the list of orders to be filled.

The data storage device includes a filled order database reflecting when an order has been filled and placed into the filled product storage area 11. The filled order database lists all orders that have been filled. It also includes the area or bin in which the filled order has been deposited after an employee packages the items. Upon arrival of a customer to the retail operation, the filled order database is accessed to confirm that the order has been filled and the location of the filled order. An employee then proceeds to the storage area, picks up the filled order and delivers it the customer.

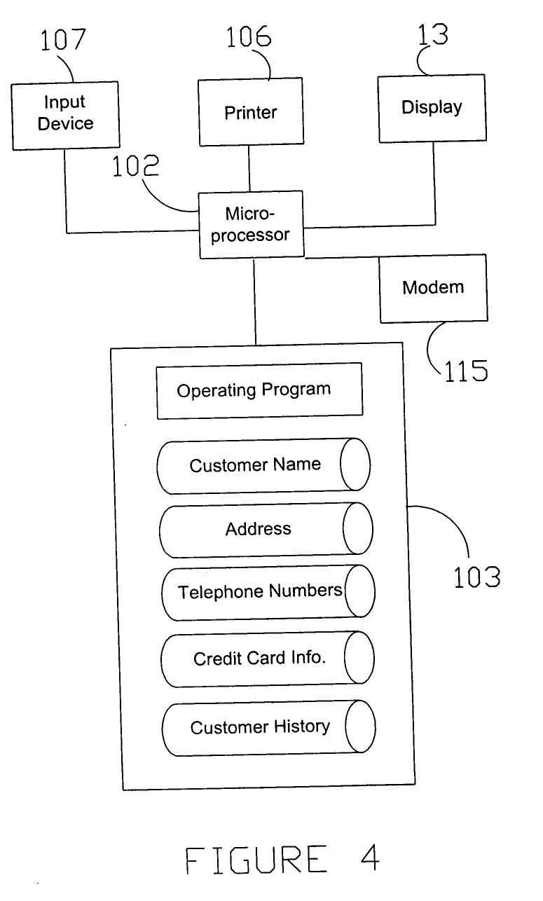

FIG. 4 is another embodiment of the single store operation and showing databases used in the operation. The microprocessor 102 communicates with at least one input device 107, printer 106 and displays 13A and 13B in the same manner as those mentioned in FIG. 3. Display 13 provides an output for store employees. An additional display may be provided for customers to confirm the order as they arrive at the pickup area. Additionally, a modem 115 or network interface device (NID) allows the microprocessor to communicate with an Internet service provider. However, it should be noted that should a direct subscriber line or other broadband communication means be used, the modem might be replaced with a router, server or other such device.

In this embodiment, the data storage device 103 includes an operating program for storing instructions that are used in controlling operation of the microprocessor and peripheral devices mentioned above. The data storage device also includes a database for storing customer names. An address database stores address information regarding customers. This information is useful for providing customers with flyers, brochures or other promotional information relating to sales, coupons or the like. A telephone number database stores the telephone number or other point-of-contact information for each customer. The telephone number database may be used by the microprocessor to identify a repeat customer when a caller identification means is attached as an input device to the microprocessor. A credit card database stores information relating to credit, debit or other type currency cards such as name on the card, card number, card type, security code, and date of expiration. Lastly, the data storage device includes a database that stores a customer's ordering history. This database may be accessed and used by the microprocessor to suggest the same items from a previous order, or to upsell substitute products. This allows the customer to reorder a plurality of items without individually specifying them. For example, if Mr. Jones orders eggs, milk and bacon on a Friday, the microprocessor will allow Mr. Jones the option of reordering these items at the time of his next purchase. The history database may also be used by the microprocessor to provide incentives to customers.

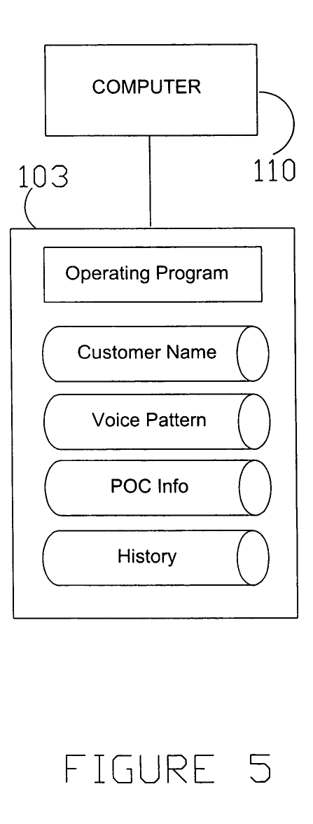

Referring now to FIG. 5, which depicts another aspect of the invention. It should be noted that “computer” 110 has been substituted for the microprocessor and peripheral devices shown in FIGS. 3 and 4. Additionally, the computer 110 comprises voice recognition hardware for sampling a customer's voice pattern for identification purposes. In this embodiment, the data storage device 103 comprises an operating program comprising instructions for controlling the computer. The data storage device also includes a database for storing customer names. A voice pattern database stores information relating to voice patterns of a customer. The computer verifies an identity of a customer based on the characteristics of unique vocal patterns. For security and convenience, a voiceprint can be used just like a fingerprint on an embedded device ensuring businesses a high level of security and convenience. The computer uses this information to quickly identify a client when an order is placed. Alternatively, caller identification hardware and software may be substituted for the voice recognition hardware and software embodiments. The data storage device also comprises a point-of-contact (POC) information database. The POC information database includes individualized data and information on each customer. This may include but is not limited to address, telephone number, facsimile number, email address, credit card information and the like. Lastly, the data storage device also includes a history database as previously mentioned in FIGS. 3 and 4.

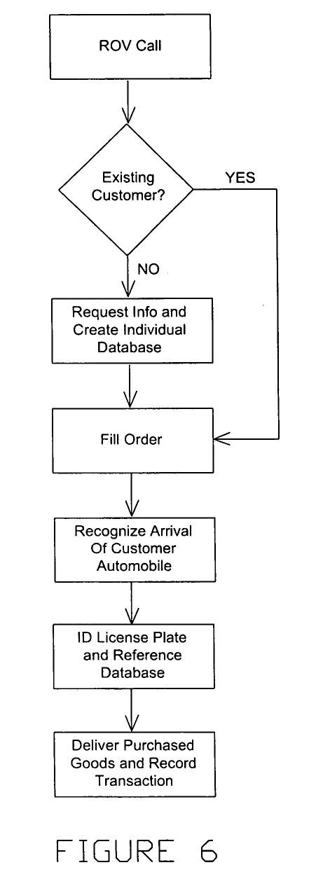

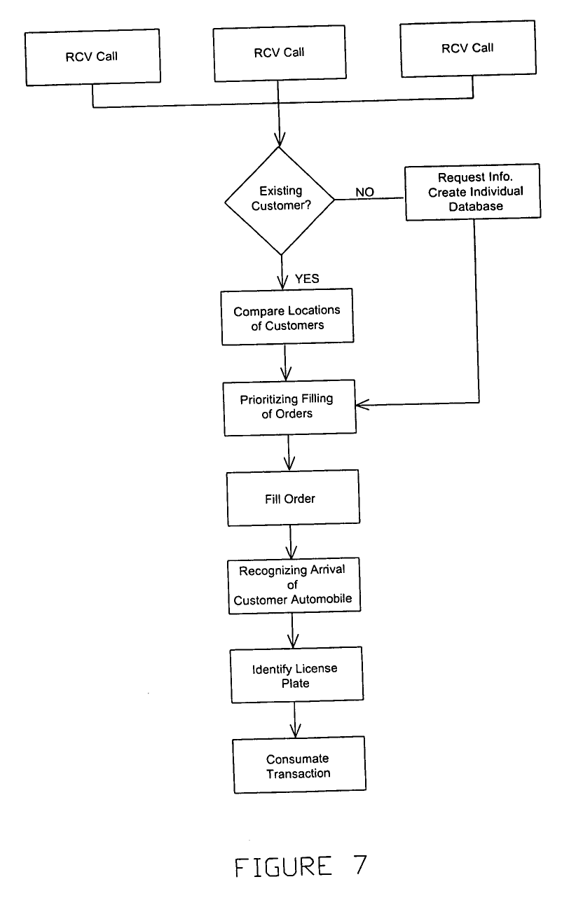

Referring now to FIGS. 6 and 7, which are flowcharts that represent the preferred methods of implementing the invention. In FIG. 6, a call, email, text message or other electronic communictaion is received from a customer. The customer is preferably remote from the retail operation. The microprocessor through use of the aforementioned caller identification or voice recognition hardware determines whether the customer has previously placed an order. Alternatively, the computer may pose a question to the customer regarding whether he is a repeat customer. If the customer has never placed an order, the computer collects the pertinent information necessary for consummating the transaction from the customer. Otherwise, the computer will allow the customer to access a menu of items for ordering purposes. If the computer determines that the customer is a repeat customer, it may also search the customer's history to determine whether the customer would like to repeat an order, as mentioned above in FIG. 4. The computer then forwards an order to a store employee to be filled. The Internal operation of microprocessor or computer may also include instructions that inform store employees of the location of ordered item. Thus, the store employee is provided a printout listing the ordered items along with their associated storage location. The employee proceeds to each location and fills the order. He then places the order in a storage location and enters the location into the computer while indicating that the filled order is awaiting pickup. This streamlines the process and makes the filling of order very easy and efficient.

Next, the computer recognizes the arrival of the customer through use of an input signal from the sensors, as previously mentioned. The camera samples the customer's license plate and the computer searches customer records to identify the customer. After identifying the customer, the computer alerts a store employee that the customer has arrived and displays the location of the customer's filled order if the customer called ahead. The employee then delivers the purchased goods and the transaction is recorded. The customer's credit or debit card is then charged. Alternatively, the store employee may accept cash, check or other payment types in lieu of charging the transaction to a credit or debit card.

Referring now to FIG. 7 that shows an embodiment wherein the computer prioritizes the filling of several orders. Several orders are placed with the computer via email or telephone or other mobile device. The computer determines whether each caller is an existing customer. If not, the computer will collect and store the pertinent information in an individual database as previously mentioned. If all calls are repeat customers, the computer compares the locations of the customers to determine the nearest customer and which order should be filled first. Other factors may also be determinative of the order in which the multiple orders are filled. Typically, each factor will be assigned a value. The values are then summed and arranged to prioritize the orders. The computer may periodically re-evaluate the value assigned to each customer. Thus, as the time since an order has been placed increase, the order will be shifted to a higher priority level for being filled. Some other these factors that may be included in prioritizing the orders may include the number of items ordered, length of time in which an order has been waiting, as well as the size of the items ordered. The location of the customers may be determined via information provided by the customer or alternatively through electronic means such as a global positioning system. The orders are filled and placed in a storage area as mentioned above. The computer recognizes the arrival of a customer and identifies him via a license recognition routine mentioned above. The transaction is then consummated as previously mentioned.

It should be noted that the data storage device might be arranged as an array having information stored in different fields rather than having separate databases as previously described.

It is to be understood that the invention is not limited to the exact construction illustrated and described above, but that various changes and modifications may be made without departing from the spirit and the scope of the invention as defined in the following claims.

1. A method for conducting a retail operation comprising:
providing a retail operation that comprises a building having two ingress/egress lanes and crossover lanes for moving from one ingress/egress lane to the other;
accepting an order from a customer via a remote communication device;
identifying said customer via at least one of a caller identification device and voice recognition device;
accessing an individualized database comprising data representative of the customer;
filling said order such that items ordered are packed and awaiting pickup by the customer upon arrival at a retail operation location.

2. The method of claim 1 further comprising:
determining a location of said customer when the order is accepted.

3. The method of claim 2 further comprising:
prioritizing orders according to the distance between the location of said customer and the retail operation location.

4. The method of claim 2 further comprising:
searching a database for locations of linked retail operations to determine the closest retail operation to the location of said customer; and,
providing directions to a linked retail operation that is nearest the location of said customer.

5. The method of claim 1 further comprising:
creating an electronic image of a license plate on an automobile driven by said customer;
converting said electronic image to data representative of characters displayed on said license plate;
comparing said data representative of characters displayed on the license plate with stored data to identify the customer upon arrival at the retail operation location, such that an order placed by said customer is correctly matched to the customer; and,
alerting an employee of said retail operation upon arrival of the customer.

6. The method of claim 1 further comprising:
recognizing purchasing tendencies of said customer to make one or more suggestions selected from a group consisting of alternative products, products featured on specials and products offered with coupons.

7. The method of claim 1 further comprising:
creating, when none exists, a database consisting of one or more selected from the following speech pattern analysis data, telephone number, address, credit card information and license plate number.

8. A retail operation comprising:
a building having two ingress/egress lanes and crossover lanes for moving from one ingress/egress lane to the other;
a receiving means that receives an order from a customer remote from the retail operation;
a microprocessor coupled to the receiving means;
a first identification means that automatically identifies the customer when placing the order and coupled to the microprocessor such that the microprocessor may access customer specific information;
an ingress roadway surface that provides access to retail operation;
a vehicle sensor provided near the roadway surface to detect arrival of the customer;
a second identification means that automatically identifies the customer upon arrival at the retail operation, said second identification means being coupled to the microprocessor; and
a pickup area for temporarily parking an automobile to allow ordered items to be loaded into a customer's automobile.

9. The retail operation of claim 8 wherein said first identification means is one selected from a group consisting of a caller identification means, a voice recognition means that identifies the customer.

10. The retail operation of claim 8 further comprising a global positioning system or location identification means that determines a location of the customer.

11. The retail operation of claim 8 wherein said second identification means includes one or more selected from a group consisting of a vehicle sensor, a camera, global position sensor, vehicle transmitter tag and a vehicle transmitter tag detector.

12. The retail operation of claim 8 further including a second ingress roadway surface and crossover lanes coupling the ingress roadway surfaces together and including at least one traffic control device for directing the flow of traffic through the crossover lanes.

13. A method for performing a retail operation that comprises a building having two ingress/egress lanes and crossover lanes for moving from one ingress/egress lane to the other and a means for identifying customers upon arrival at the retail operation, said retail operation including at least two points of sales that include computer terminals that alert retail operation employees upon arrival of the customers to convey information on a storage location customer orders, said method comprising:
providing two ingress/egress lanes and crossover lanes for moving from one ingress/egress lane to the other and a means for identifying customers upon arrival at the retail operation, said retail operation including at least two points of sales that include computer terminals that alert retail operation employees upon arrival of the customers to convey information on a storage location customer orders;
accepting an order from a customer via a remote communication device;
identifying said customer via at least one of a caller identification device and voice recognition device;
accessing an individualized database comprising data representative of the customer;
filling said order such that items ordered are packed and awaiting pickup by the customer upon arrival at a retail operation location.

14. The method of claim 13 further comprising:
communicating with a customer that may include accepting orders, calculating a cost of an order, providing directions to the retail operation, prioritizing the filling of multiple orders to include controlling use of storage bins, identifying customers upon arrival at the retail store matching the identified customer to the placed order and alerting an employee of the store when the customer arrives while informing the employee where the order is stored.

15. The method of claim 13 further comprising positively identifying the customer by one or more means selected from a group consisting of cameras, GPS data, vehicle identification number, and a vehicle transmitter tag.

16. The method of claim 13 further comprising maintaining a database that may be accessed by multiple stores.

17. The method of claim 13 further suggesting an alternative store based on one or more conditions selected from a group consisting of a location a retail operation nearest a customer's location when an order is placed or whether an item is in stock in one store and not another.
